(19) United States
(12) Patent Application Publication
(10) Pub. No.: US 2004/0168579 A1
(43) Pub. Date: Sep. 2, 2004

(54) Grill unit, method of manufacturing the grill unit and cooking apparatus with the grill unit

(75) Inventors: Dae-Sung Han, Hwasung-City (KR); Chul Kim, Yongin-City (KR); Yong-Woon Han, Kunpo-City (KR); Seong-Deog Jang, Suwon-City (KR); Kyung-Hee Hahm, Seoul (KR); Joo-Yeong Yeo, Hwasung-City (KR); Han-Seong Kang, Suwon-City (KR)

Correspondence Address: STAAS & HALSEY LLP, SUITE 700, 1201 NEW YORK AVENUE, N.W., WASHINGTON, DC, 20005, US

(73) Assignee: Samsung Electronics Co. Ltd., Suwon City (KR)

(21) Appl. No.: 10/691,551

(22) Filed: Oct. 24, 2003

(30) Foreign Application Priority Data
Feb. 6, 2003 (KR) 2003-7555

(51) Int. Cl. A23F 3/00

(52) U.S. Cl. 99/288

(57) ABSTRACT

A grill unit, including a plurality of grill pipes made of a metallic material and spaced apart from each other; and water tanks made of a resin material and connected to both ends of the grill pipes to supply water into the grill pipes.

### CROSS-REFERENCE TO RELATED APPLICATIONS

This application claims the benefit of Korean Application No. 2003-7555, filed Feb. 6, 2003, in the Korean Intellectual Property Office, the disclosure of which is incorporated herein by reference.

### BACKGROUND OF THE INVENTION

1. Field of the Invention

The present invention relates, in general, to a grill unit, a method of manufacturing the grill unit, and a cooking apparatus with the grill unit, and, more particularly, to a grill unit which may be easily manufactured at a low cost, a method of manufacturing the grill unit, and a cooking apparatus with the grill unit.

2. Description of the Related Art

Generally, it is well known that meat or processed meat, such as sausage, is most delicious when grilled. Therefore, persons enjoy cooking meat or processed meat using a cooking apparatus with a grill unit and eating the cooked meat or processed meat.

The cooking apparatus for this kind of cooking includes a heating unit for directly applying heat to food, and a grill unit mounted on top of the heating unit to support food while spacing the food apart from the heating unit. This structure allows food put on the grill unit to be heated by heat transferred from the heating unit. However, when cooking is performed using the cooking apparatus equipped with a grill unit, high temperature heat is directly transferred from the heating unit to the grill unit, so the part of food in contact with the grill unit easily burns, thus deteriorating the taste of the food and negatively affecting the health of those eating the burned food.

### SUMMARY OF THE INVENTION

It is an aspect of the present invention to provide a grill unit that may be easily manufactured at a low cost, a method of manufacturing the grill unit, and a cooking apparatus with the grill unit.

Additional aspects and/or advantages of the invention will be set forth in part in the description that follows and, in part, will be obvious from the description, or may be learned by practice of the invention.

To achieve the above and/or other aspects of the present invention, there is provided a grill unit, including a plurality of grill pipes made of a metallic material and spaced apart from each other; and water tanks made of a resin material and connected to both ends of the grill pipes to supply water into the grill pipes.

Each end of each of the grill pipes comprises a laterally extended part with a predetermined length, an upwardly extended part upwardly bent and extended from the laterally extended part and opened at a top thereof to interface with an inside of a corresponding one of the water tanks.

Each of the water tanks has a lower portion and a side portion, with the lower portion of each of the water tanks, which receives the ends of the grill pipes, being thicker than the side portion.

The grill includes covers over each of the water tanks to selectively open and close each of the water tanks.

Each of the grill pipes has a horizontally extended part on which food is placed that is bent to be positioned lower than both ends of the grill pipes connected to the water tanks to position the food near a heating source arranged below the food.

The grill unit includes a transparent window on at least one of the water tanks to ascertain a water level inside the at least one of the water tanks.

The grill unit includes a transparent pipe connected to at least one of the water tanks, the ends of the transparent pipe entering an inside of the water tank to ascertain a water level inside the at least one of the water tanks.

To achieve the above and/or other aspects of the present invention, there is provided a method of manufacturing a grill unit using metallic molds, the grill unit having a plurality of grill pipes and a water tank, the method comprising: fixing ends of a plurality of grill pipes into at least one of the metallic molds used to mold the water tank, while maintaining the ends of the grill pipes in the at least one of the metallic molds; and molding the water tank by injecting molten resin into the at least one of the metallic molds.

The grill unit manufacturing method includes cutting a pipe into the plurality of grill pipes, each grill pipe having a predetermined length, and upwardly bending the ends of the grill pipes before inserting and fixing the ends of the grill pipes in the at least one of the metallic molds.

To achieve the above and/or other aspects of the present invention, there is provided a cooking apparatus, including a cabinet having at least one heater; and a grill unit mounted on a top surface of the cabinet to support food, the grill unit having a plurality of grill pipes made of a metallic material and spaced apart from each other, and water tanks made of a resin material and connected to both ends of the grill pipes to supply water into the grill pipes.

To achieve the above and/or other aspects according to the present invention, there is provided a method of manufacturing a grill unit having a plurality of grill pipes and a water tank formed using detachable molds, the method including cutting a pipe at predetermined intervals to form the plurality of grill pipes; bending and shaping an end of the grill pipes to form an upwardly extended part to contact water in the water tank, a laterally extended part extending from the upwardly extended part, a sloped part sloping downward from the laterally extended part, and a horizontally extended part extending from the inclined part; setting the upwardly extended part and the laterally extended part of each of the grill pipes within a cavity formed between the molds; molding the water tank by injecting molten resin into the cavity to integrally form the grill pipes with the water tank; and removing the molds from the water tank after the resin has solidified, with the horizontally extended part being lower than the water tank.

To achieve the above and/or other aspects according to the present invention, there is provided a grill unit, including a plurality of grill pipes made of a metallic material and spaced apart from each other; water tanks made of a resin material and connected to both ends of the grill pipes to supply water into the grill pipes; and a transparent window on at least one of the water tanks to indicate a water level inside the at least one of the water tanks.

To achieve the above and/or other aspects according to the present invention, there is provided a grill unit, including a plurality of grill pipes made of a metallic material and spaced apart from each other; water tanks made of a resin material and connected to both ends of the grill pipes to supply water into the grill pipes; and a transparent pipe connected to at least one of the water tanks to indicate a water level inside the at least one of the water tanks, the ends of the transparent pipe entering an inside of the water tank.

These, together with other aspects and/or advantages that will be subsequently apparent, reside in the details of construction and operation as more fully hereinafter described and claimed, reference being had to the accompanying drawings forming a part thereof, wherein like numerals refer to like parts throughout.

### BRIEF DESCRIPTION OF THE DRAWINGS

These and/or other aspects and advantages of the invention will become apparent and more readily appreciated from the following description of the preferred embodiments, taken in conjunction with the accompanying drawings, of which:

FIG. 1 is an exploded perspective view of a cooking apparatus with a grill unit according to the present invention;

FIG. 2 is a sectional view showing the construction of the grill unit of the present invention;

FIG. 3 is a detailed sectional view showing a part of the grill unit indicated by portion III of FIG. 2;

FIG. 4 is a view showing a process of manufacturing the grill unit of the present invention;

FIG. 5 is a perspective view showing the construction of a transparent window on a water tank of the grill unit of the present invention; and

FIG. 6 is a perspective view showing the construction of a transparent pipe on the water tank of the grill unit of the present invention.

### DETAILED DESCRIPTION OF THE PREFERRED EMBODIMENT

Hereinafter, an embodiment of the present invention will be described in detail with reference to the attached drawings, wherein the like reference numerals refer to the like elements throughout. The present invention may, however, be embodied in many different forms and should not be construed as being limited to the embodiment set forth herein; rather, this embodiment is provided so that the present disclosure will be thorough and complete, and will fully convey the concept of the invention to those skilled in the art.

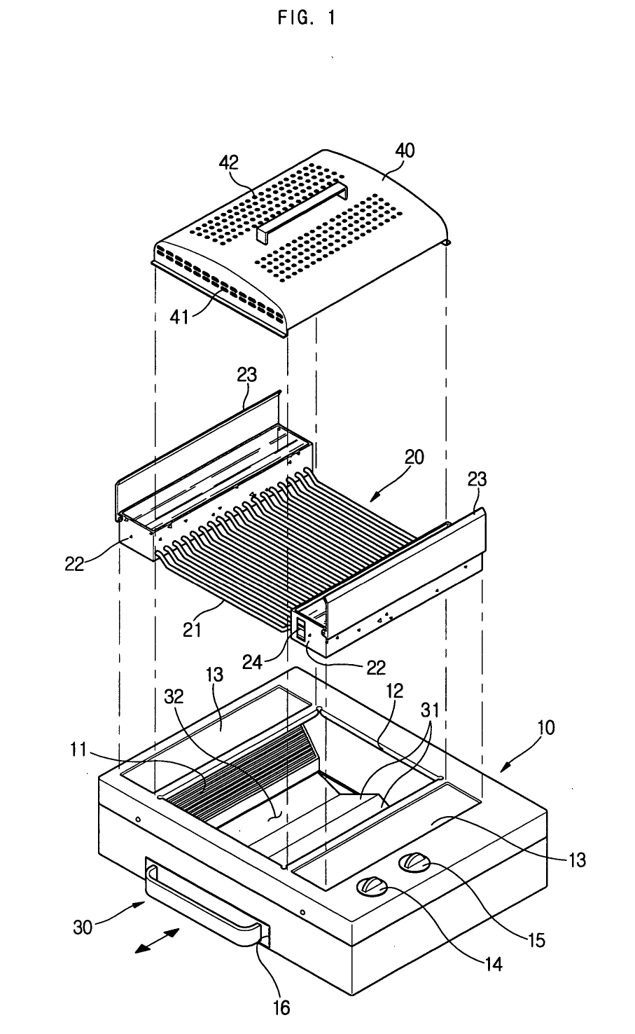

As shown in FIG. 1, a cooking apparatus with a grill unit according to the present invention includes a cabinet 10 formed in a box shape, and a grill unit 20 mounted on a top of the cabinet 10 to grill food put on the grill unit 20. Further, the cooking apparatus includes a plurality of heaters 11 mounted in the cabinet 10 to heat food put on the grill unit 20, a heat reflecting member 30 that guides the heat from the heaters 11 to the food on the grill unit 20 and collects oil dripping from the food, and a cover member 40 that covers the upper portion of the grill unit 20 and has a plurality of holes 41 and 42 perforated therethrough.

The cabinet 10 has an opening 12 formed in the top thereof to allow heat generated by the heaters 11 mounted in the cabinet 10 to be transferred to the grill unit 20. Grill seats 13, each with a predetermined area, are formed on both sides of the top surface of the cabinet 10 around the opening 12 to allow the grill unit 20 to be seated thereon. Further, a timer switch 14 and a power switch 15 are provided at a certain portion of a top surface of the cabinet 10 to control the heating time and the heating temperature of the heaters 11, respectively. An opening 16 is formed in a lower portion of the front of the cabinet 10 so that the heat reflecting member 30 may be moved into and out of the cabinet 10 through the opening 16, similar to the operation of a drawer.

The heaters 11 are set within both sides of the cabinet 10, that is, below the grill seats 13, to heat food put on the grill unit 20, and are inclined at a predetermined angle such that heating surfaces of the heaters 11 face the opening 12 formed in the top of the cabinet 10. The heaters 11 each include a ceramic member in which heating elements are encapsulated to generate infrared rays with a high temperature. However, the heaters 11 may be implemented as gas heaters using gas, or as trays for holding charcoal.

The heat reflecting member 30 is constructed such that its axial center portion is projected upward to form a hill shape with a triangular cross-section, and both projected surfaces form reflecting surfaces 31 to allow heat generated by the heaters 11 to be reflected to the grill unit 20 arranged above the heaters 11. Further, recesses 32 are formed at bottoms of both projected surfaces to collect oil dripping from food put on the grill unit 20. Further, although not shown in FIG. 1, a predetermined amount of water is contained in the heat reflecting member 30 to prevent the temperatures of the recesses 32 and the reflecting surfaces 31 from increasingly excessively, thus preventing oil collected in the recesses 32 from burning or adhering to the recesses 32.

The grill unit 20 includes a plurality of grill pipes 21 arranged in parallel with each other while being spaced apart from each other, water tanks 22 connected to both ends of the grill pipes 21 to supply water into the grill pipes 21 and provided with bottom surfaces seated on the grill seats 13 of the top surface of the cabinet 10, and covers 23 to selectively open and close upper portions of the water tanks 22.

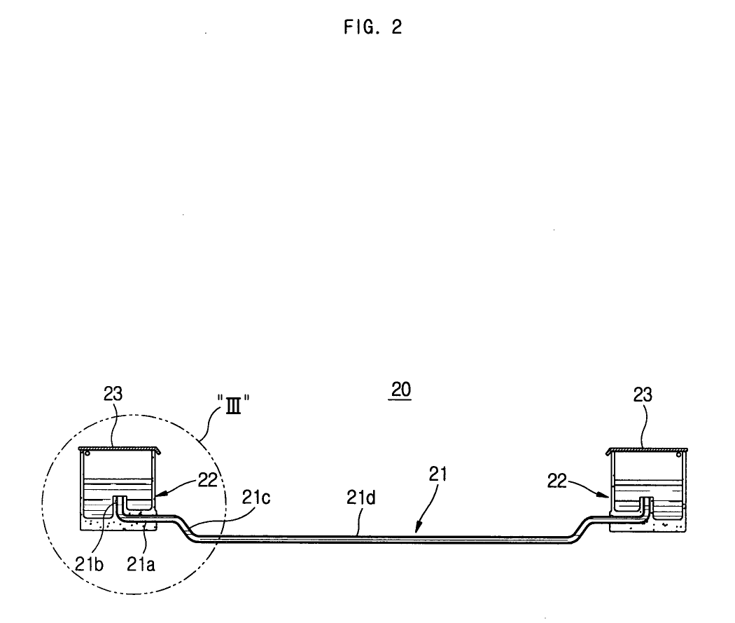

Further, as shown in FIG. 2, the grill pipes 21 are made of a metallic material and the water tanks 22 on both sides thereof are manufactured through injection molding of a resin material. That is, after both ends of the grill pipes 21 are inserted into metallic molds used to mold the water tanks 22, the water tanks 22 are molded using injection molding so that both ends of the grill pipes 21, which are made of the metallic material, are integrally connected to the water tanks 22 made of the resin material.

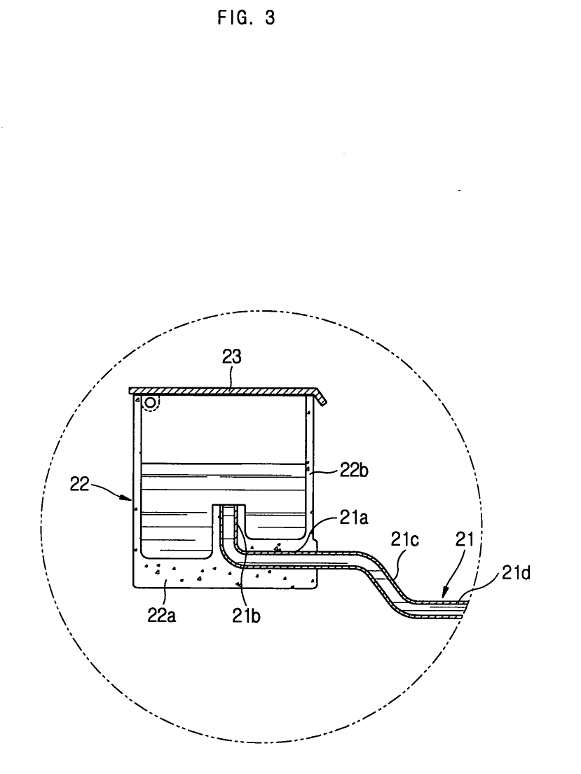

As shown in FIG. 3, a lower portion 22a of each of the water tanks 22, into which the grill pipes 21 are inserted, is thicker than a side portion 22b thereof. Both ends of each of the grill pipes 21 inserted into the lower portions 22a of the water tanks 22 include a laterally extended part 21a that is laterally extended by a predetermined length, and an upwardly extended part 21b that is upwardly bent and extended from the laterally extended part 21a and open at the top thereof to interface with an inside of each of the water tanks 22. This construction reinforces the rigidity of portions where both ends of the grill pipes 21 and the water tanks 22 are connected to each other, which are kept watertight.

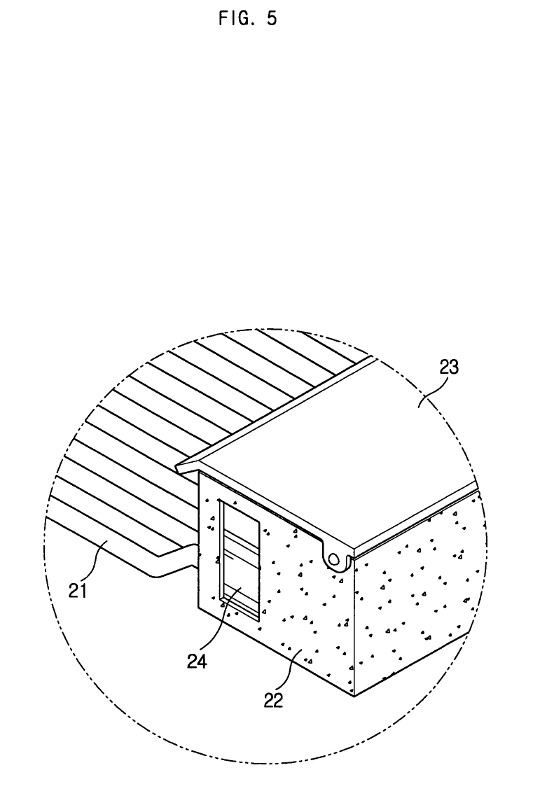

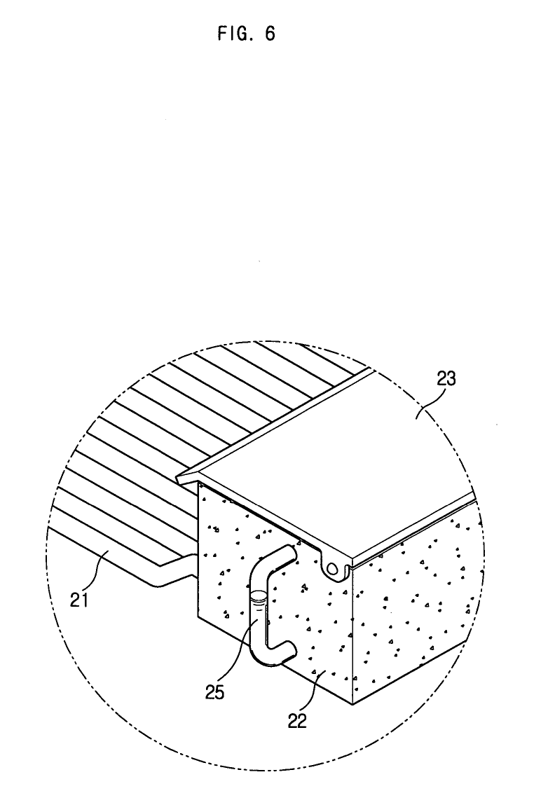

To enable a user to visually ascertain a level of water in the water tanks 22, a transparent window 24 (as shown in FIG. 5) or a transparent pipe 25 (as shown in FIG. 6) is provided on an outside surface of at least one of the water tanks 22. The transparent pipe 25 is connected to the water tank 22 so that upper and lower portions thereof connect to the inside of the water tank 22.

As shown in FIGS. 2 and 3, each of the grill pipes 21 has a horizontally extended part 21d on which food is placed. The horizontally extended part 21d is bent to be positioned lower than both ends of the grill pipes 21 connected to the water tanks 22 so that the food is positioned near the heaters 11 arranged below the food. That is, each of the grill pipes 21 has two inclined parts 21c downwardly bent at a predetermined angle and extended from end parts connected to the water tanks 22. Each of the grill pipes 21 is bent to be horizontally extended between the inclined parts 21c, so that the horizontally extended part 21d on which the food is placed is lower than the water tanks 20.

The above-described construction of the grill unit 20 prevents the grill pipes 21 from overheating by allowing water to flow into the grill pipes 21 from the water tanks 22, even though the grill pipes 21 are heated by heat transferred from the heaters 11 arranged below the grill unit 20 when the user grills food, thereby preventing the part of food in contact with the grill pipes 21 from burning. Also, the water tanks 22 are made of a resin material, rather than a metallic material, and are manufactured through injection molding so that the grill unit may be easily manufactured with reduced manufacturing costs relative to conventional grill units made of a metallic material. Further, the water tanks 22 are made of a resin material so that the temperature of the surface of the water tanks 22 is lower than that of water tanks made of a metallic material, thus increasing convenience and safety of use.

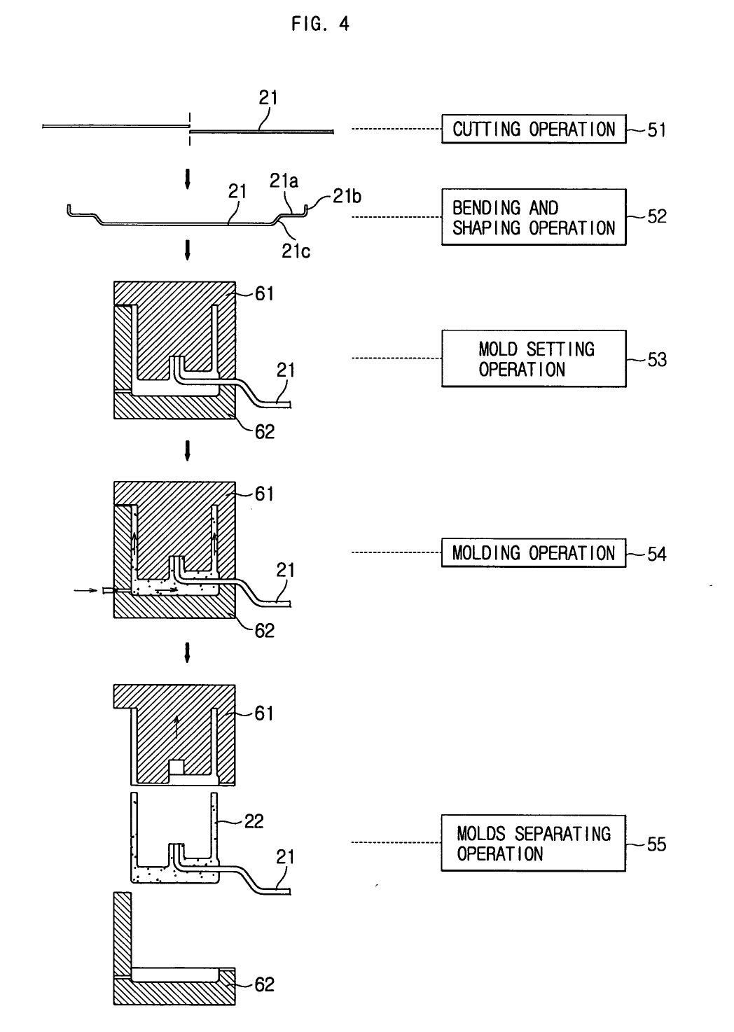

Referring to FIG. 4, the grill unit 20 is manufactured by first performing a cutting operation 51 to cut a pipe made of stainless steel, for example, into a plurality of grill pipes 21 having an appropriate length. A bending and shaping operation 52 is performed to bend and shape the grill pipes 21 using a jig (not shown), for example, to form the upwardly extended parts 21b, the laterally extended parts 21a, the inclined parts 21c, and the horizontally extended part 21d for each of the grill pipes 21.

After the bending and shaping operation 52 is performed, a mold setting operation 53 is performed to insert both ends of the grill pipes 21 into respective pairs of an upper metallic mold 61 and a lower metallic mold 62 used to mold the water tanks 22. The upper metallic mold 61 and the lower metallic mold 62 are detachably connected to each other.

After the metallic molds 61 and 62 have been set, a molding operation 54 is performed using an injecting device (not shown) to inject molten resin into an empty space within the metallic molds 61 and 62. thus, both ends of the grill pipes 21, inserted into the metallic molds 61 and 62 in advance, are embedded in the molten resin.

After the molten resin, which has been injected into the metallic molds 61 and 62, has solidified to form the water tanks 22, a molds separating operation 55 is performed to separate the metallic molds 61 and 62. Finally, after the covers 23 are respectively installed over an upper opening of each of the water tanks 22, the manufacture of the grill unit 20 is completed.

As is apparent from the above description, the present invention provides a grill unit in which water tanks, which are conventionally made of a metallic material, are made of a resin material through injection molding, thus enabling easy manufacture of the grill unit and greatly reduced manufacturing costs relative to conventional grill units.

Further, the present invention is advantageous in that the water tanks of the grill unit are made of a resin material so that the temperature of the surface of the water tanks is lower than that of water tanks made of a metallic material, thus increasing convenience and safety of use.

Although an embodiment of the present invention has been shown and described, it will be appreciated by those skilled in the art that changes may be made in this embodiment without departing from the principles and spirit of the invention, the scope of which is defined in the claims and their equivalents.

What is claimed is:

1. A grill unit, comprising:
a plurality of grill pipes made of a metallic material and spaced apart from each other; and
water tanks made of a resin material and connected to both ends of the grill pipes, to supply water into the grill pipes.

2. The grill unit according to claim 1, wherein each end of each of the grill pipes comprises a laterally extended part with a predetermined length, an upwardly extended part upwardly bent and extended from the laterally extended part and opened at a top thereof to interface with an inside of a corresponding one of the water tanks.

3. The grill unit according to claim 2, wherein each of the water tanks has a lower portion and a side portion, with the lower portion of each of the water tanks, which receives the ends of the grill pipes, being thicker than the side portion.

4. The grill unit according to claim 1, further comprising covers respectively over each of the water tanks to selectively open and close each of the water tanks.

5. The grill unit according to claim 1, wherein each of the grill pipes has a horizontally extended part on which food is placed that is bent to be positioned lower than both ends of the grill pipes connected to the water tanks to position the food near a heating source arranged below the food.

6. The grill unit according to claim 1, further comprising a transparent window on at least one of the water tanks to ascertain a water level inside the at least one of the water tanks.

7. The grill unit according to claim 1, further comprising a transparent pipe connected to at least one of the water tanks, the ends of the transparent pipe entering an inside of the water tank to ascertain a water level inside the at least one of the water tanks.

8. A method of manufacturing a grill unit using metallic molds, the grill unit having a plurality of grill pipes and a water tank, the method comprising:
fixing ends of a plurality of grill pipes into at least one of the metallic molds used to mold the water tank, while maintaining the ends of the grill pipes in the at least one of the metallic molds; and
molding the water tank by injecting molten resin into the at least one of the metallic molds.

9. The grill unit manufacturing method according to claim 8, further comprising cutting a pipe into the plurality of grill pipes, each grill pipe having a predetermined length, and upwardly bending the ends of the grill pipes before inserting and fixing the ends of the grill pipes in the at least one of the metallic molds.

10. A cooking apparatus, comprising:
a cabinet having at least one heater; and
a grill unit mounted on a top surface of the cabinet to support food, the grill unit comprising
a plurality of grill pipes made of a metallic material and spaced apart from each other, and
water tanks made of a resin material and connected to both ends of the grill pipes to supply water into the grill pipes.

11. The cooking apparatus according to claim 10, wherein each end of each of the grill pipes comprises a laterally extended part with a predetermined length, an upwardly extended part upwardly bent and extended from the laterally extended part and opened at a top thereof to interface with an inside of a corresponding one of the water tanks.

12. The cooking apparatus according to claim 11, wherein each of the water tanks has a lower portion and a side portion, with the lower portion of each of the water tanks, which receives the ends of the grill pipes, being thicker than the side portion.

13. The cooking apparatus according to claim 10, further comprising covers respectively over each of the water tanks to selectively open and close each of the water tanks.

14. The cooking apparatus according to claim 11, wherein each of the grill pipes has a horizontally extended part on which food is placed that is bent to be positioned lower than both ends of the grill pipes connected to the water tanks to position the food near the at least one heater arranged below the food.

15. The cooking apparatus according to claim 10, further comprising a transparent window on at least one of the water tanks to ascertain a water level inside the at least one of the water tanks.

16. The cooking apparatus according to claim 14, wherein each end of each of the grill pipes has an inclined part downwardly bent at a predetermined angle and extended from a respective laterally extended part, the horizontally extended part of each grill pipe extending between respective inclined parts to position the horizontally extended part lower than the water tanks.

17. The cooking apparatus according to claim 10, wherein the water supplied into the grill pipes from the water tanks prevents the grill pipes from overheating when heat is applied to the grill pipes, thereby preventing food placed on the grill pipes from burning.

18. A method of manufacturing a grill unit having a plurality of grill pipes and a water tank formed using detachable molds, the method comprising:
cutting a pipe at predetermined intervals to form the plurality of grill pipes;
bending and shaping an end of each of the grill pipes to form an upwardly extended part to contact water in the water tank, a laterally extended part extending from the upwardly extended part, a sloped part sloping downward from the laterally extended part, and a horizontally extended part extending from the inclined part;
setting the upwardly extended part and the laterally extended part of each of the grill pipes within a cavity formed between the molds;
molding the water tank by injecting molten resin into the cavity to integrally form the grill pipes with the water tank; and
removing the molds from the water tank after the resin has solidified, with the horizontally extended part being lower than the water tank.
